(19) United States
(12) Patent Application Publication
(10) Pub. No.: US 2008/0155578 A1
(43) Pub. Date: Jun. 26, 2008

(54) Optical Disk Drive Unit Having a Cooling Device

(75) Inventors: Joo Pheng Toh, Singapore (SG); Chin Beng Goh, Singapore (SG); Boon Heng Guah, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/816,300

(22) PCT Filed: Feb. 3, 2006
(86) PCT No.: PCT/IB06/50366

§ 371 Date: Aug. 15, 2007

(30) Foreign Application Priority Data
Feb. 18, 2005 (EP) 05101219.3

(51) Int. Cl. G11B 33/14; G06F 1/20

(52) U.S. Cl. 720/649

(57) ABSTRACT

A disk drive unit, such as a DVD recorder, comprises a turntable (3) having an axis of rotation (2′). An optical pickup unit (4) is provided next to the turntable. A cooling device directs a cooling air stream to the optical pickup unit to cool the hot components thereof. The cooling device comprises a centrifugal blower (5) having an axis of rotation (5′) substantially parallel to that of the turntable. The centrifugal blower (5) is accommodated in a housing (7) which is attached to a side of the disk drive unit within the height dimensions of the disk drive unit. This may lead to a cooling device having a high cooling capacity and a low noise level and which does not affect the height dimensions thereof.

### FIELD OF THE INVENTION

The invention relates to a disk drive unit for reading and/or writing data on a disk, comprising a turntable having an axis of rotation, an optical pickup unit provided next to the turntable, and a cooling device for directing a cooling air stream to the optical pickup unit.

### BACKGROUND OF THE INVENTION

One of the limiting factors for the performance of optical disk drive units, such as DVD recorders, is the temperature specification of the laser diode. As the writing speed increases the required laser power (and hence the temperature) has to be increased accordingly. Currently, set makers have to make use of an external fan to lower the temperature inside the set. This imposes a restriction on the design of the recorder set as the fan has to be positioned at strategic locations to carry off the heat of the disk drive unit. The height of the recorder set is also limited by the diameter of the fan. Examples of such a prior art disk drive unit are disclosed in U.S. Pat. No. 4,771,412 and JP-A-06236677.

Another solution is disclosed in JP-A-2002184167 in which a small fan is used. To achieve proper cooling effects, the fan has to be set at a high rotational speed and this induces noise. Then it is still questionable whether a sufficient cooling effect is created.

It is an object of the present invention to provide a pickup unit having an improved cooling device.

### SUMMARY OF THE INVENTION

In order to accomplish this objective, the pickup unit according to the invention comprises a centrifugal blower having an axis of rotation substantially parallel to that of the turntable.

In the disk drive unit according to claim 1, the use of a centrifugal blower makes that a large cooling flow can be created without causing annoying fan noise and without increasing the height dimensions of the disk drive unit. In this context it is preferred to apply the feature of claim 2. Due to the better cooling, the performance of the disk drive unit, such as a DVD recorder, at high temperatures can be increased considerably.

The embodiment of claim 3 has the advantage that a relatively large air intake from two sides can be created leading to a large cooling flow.

The embodiment of claim 4 automatically leads to the creation of an outlet for the centrifugal airflow.

In the embodiment of claim 5, the air is directed towards the pickup unit and, consequently, away from the disk which is supported by the turntable. This avoids interference of the air with the rotating disk which would affect the recording performance.

The invention also includes a cooling device for an optical pickup unit of a disk drive unit for directing a cooling air stream to the optical pickup unit, as claimed in claim 10.

These and other aspects and advantages of the invention will be apparent from the following description with reference to the drawings.

### BRIEF DESCRIPTION OF THE DRAWINGS

FIG. 1 is a cut-away perspective view of a preferred embodiment of a disk drive unit having a cooling device according to the invention;

FIG. 2 is a top view of the cooling device of FIG. 1.

FIG. 3 is a perspective bottom view of the disk drive unit of FIG. 1 on a smaller scale.

FIG. 4 is a view similar to that of FIG. 3 but with the cooling device removed.

FIG. 5 is a larger scale perspective bottom view of the fan plate of the cooling device in the disk drive unit of FIG. 1.

### DESCRIPTION OF THE PREFERRED EMBODIMENTS

The drawings show a preferred embodiment of a disk drive unit according to the invention. This disk drive unit may be used in a device for reading and/or writing data on a disk, such as a DVD recorder, which is adapted to read/and or write disks for audio, video and/or data by means of an optical reading and/or writing member, in particular a laser diode.

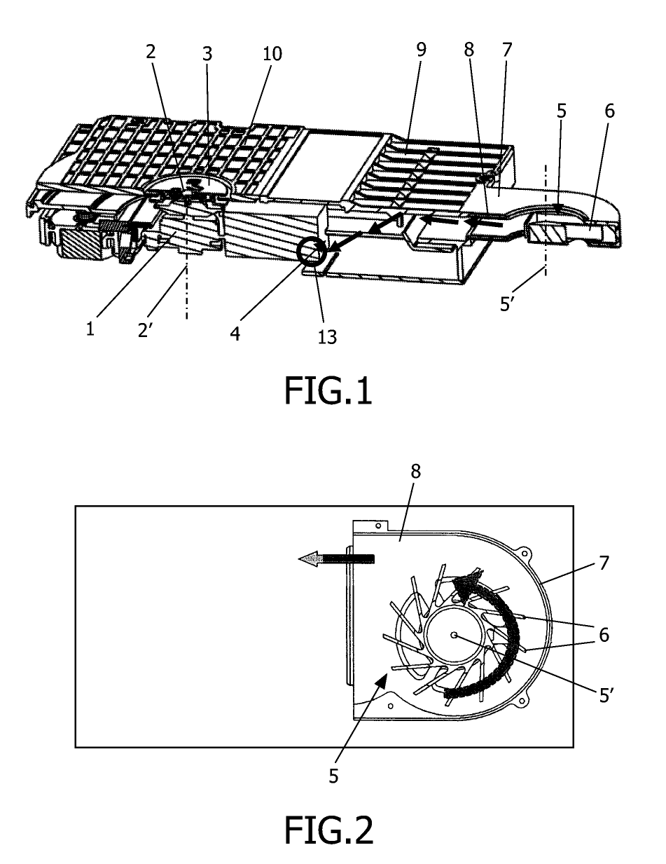

FIG. 1 shows such a disk drive unit including a motor 1, a spindle 2 driven by the motor 1, and a turntable 3 connected to the spindle 1. The spindle 2 determines the axis of rotation 2′ of the turntable 3. The disk drive unit also includes an optical system 4 including a pickup unit to read/write the data from/onto a disk D. The pickup unit is provided next to the turntable and is movable with respect thereto. The optical system 4 includes a laser diode and lenses. When the system is in use a disk (not shown) is supported by the turntable 3. For this purpose, the disk has its clamping area engaged by the turntable 3 in order to be driven.

In practice the laser of the optical system becomes very hot and requires cooling to operate at high performance. Therefore the invention provides a cooling device, in this embodiment in the form of a centrifugal blower fan 5. The blower 5 has an axis of rotation 5′ which is parallel to the axis of rotation 2′ of the turntable 3. Due to this orientation of the blower axis, the blower 5 has a horizontal orientation in line with the disk drive unit.

The blower includes blades 6 which are preferably straight and are positioned at an angle to the respective radial to the axis of rotation. The blower 5 is accommodated in a blower housing 7, in a position off-centred with respect to the inner space in the housing so as to create an airflow outlet 8. The air inlet is provided on both sides of the housing 7 so that air can be sucked into the housing from two axial sides. The air outlet 8 is directed substantially tangential to the blower 5. Due to this construction the blower 5 may have a high capacity at low noise levels.

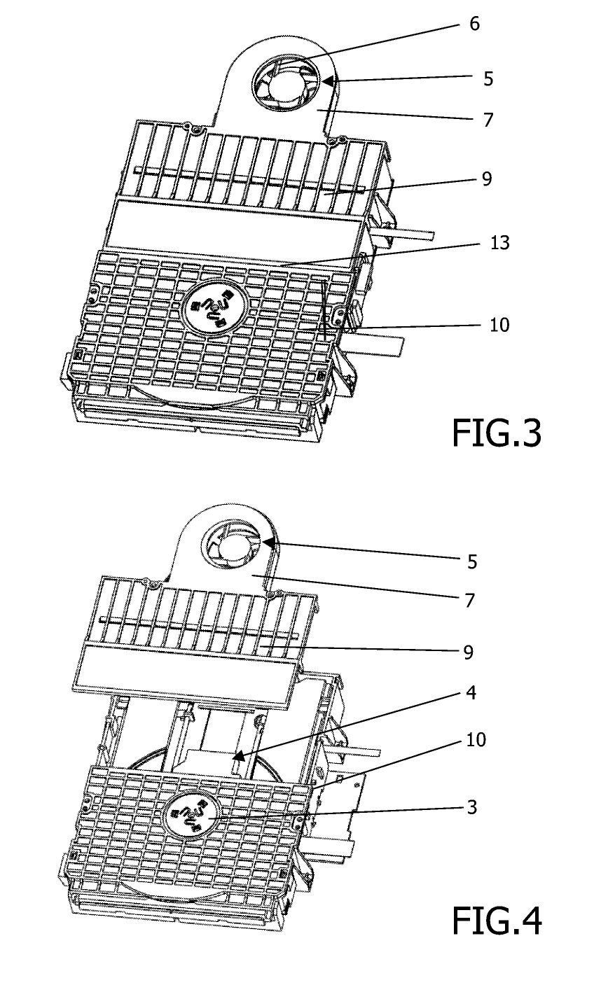

The housing 7 of the blower is relatively flat and has a smaller height than the housing 10 of the disk drive. One side of the blower housing connects to a fan plate 9 which forms a part of a side of the housing 10 (see also FIGS. 3 and 4). The fan plate 9 may be integrated with the blower housing and may be flush with one side of the blower housing 7. The blower 5 and the fan plate 9 are provided at the side of the disk drive housing 10 where the pickup unit 4 is positioned. The fan plate also acts as mounting means for the blower housing 7 in order to mount the blower to the housing 10 of the disk drive unit.

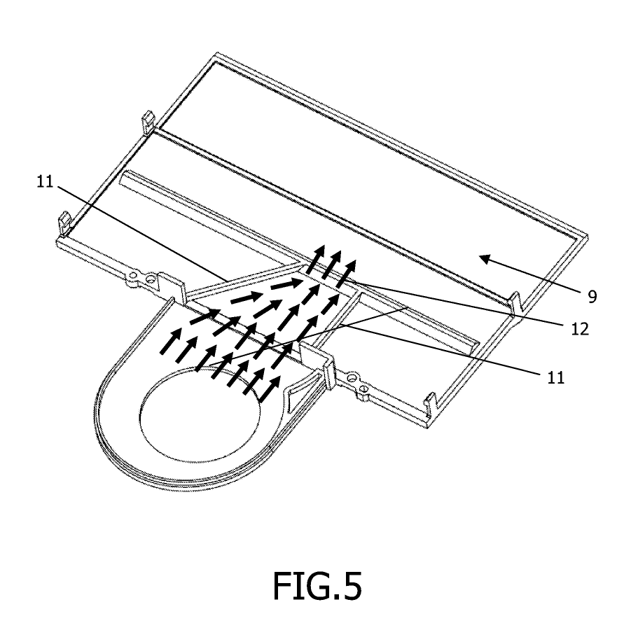

As is shown in FIG. 5, the inside of the fan plate 9 has flow guide means, here guide ribs 11, to converge the air flow exiting from the blower air outlet 8 in order to improve the convection. It comprises further flow guide means, here a further guide rib 12, to deflect the airflow away from the fan plate 9. The guide rib 12 extends substantially perpendicularly to the airflow and has an inclined face at its side facing the airflow. Due to this deflection of the airflow, it is directed away from the disk on the turntable 3 and towards the pickup unit, in particular the laser diode thereof. Thus, the airflow is not interfering with the rotating disk and is directed to the spot where cooling is required most. From the pickup unit, the airflow is directed out of the housing 10 through an opening 13.

The housing of the device, such as a DVD recorder, may be sealed for dust as no air from outside the device is necessary. Cooling air for the pickup unit may be circulated within the device. The disk drive unit itself does therefore not need dust protection.

The blower fan in the disk drive unit may be of the dynamic type having variable rotational speeds. This further reduces noises produced by the blower. For the dynamic behaviour use can be made of a temperature sensor which is generally present in pickup units to sense the temperature of the laser diode. The temperature sensor readings can be used to adjust the blower speed accordingly, thus making the blower speed control a closed loop control with the temperature as the feedback. This will ensure that the noise pollution is kept to a minimum (the blower can even be switched off when the laser diode temperature is low).

From the foregoing it should be understood that the disk drive unit and cooling device according to the invention provide a simple and very effective means to improve the performance of the laser of a pickup unit while the noise level can be kept low and the design freedom is hardly restricted.

It is noted that in specification and claims, the use of the expressions “a” or “an” does not exclude a plurality thereof, whereas the expression “comprising” does no exclude additional elements or steps. Reference signs in the claims shall not be construed as limiting the scope thereof. A single processor or unit may fulfil the functions of several elements in the appended claims.

In the preferred embodiments, the disk is an optical data disk. However, it should be understood that the invention can also be used for all kinds of other disks e.g. ferro-electric, magnetic, magneto-optic, near-field, active charge storage disks or other disks using combinations of these techniques or other reading and/or writing techniques. In these cases the lens and laser will be replaced by another reading/writing member which may require cooling.

The invention is not limited to the embodiments shown in the drawing and described hereinbefore which may be varied in different manners within the scope of the appended claims. For example, the blower may be mounted in another position or with a different orientation. The blower may be of a different type and the flow guide means may have another structure or be formed on other parts of the disk drive unit.

1-10. (canceled)

11. Disk drive unit for reading and/or writing data on a disk, comprising a turntable (3) having an axis of rotation (2′), an optical pickup unit (4) provided next to the turntable, and a cooling device for directing a cooling air stream to the optical pickup unit, said cooling device comprising a centrifugal blower (5) having an axis of rotation (5′) substantially parallel to the axis of rotation of the turntable, wherein the centrifugal blower (5) is accommodated in a housing (7) which is attached to a side of the disk drive unit within the height dimensions of the disk drive unit.

12. Disk drive unit according to claim 11, wherein the blower (5) has straight fan blades (6) and includes axial air inlets from both sides.

13. Disk drive unit according to claim 11, wherein the axis of rotation of the blower (5) is positioned off-centred with respect to a housing (7) in which the blower is accommodated.

14. Disk drive unit according to claim 1, wherein the blower (5) is attached to a fan plate (9) which includes flow guide means (11, 12) for directing air towards the pickup unit (4).

15. Disk drive unit according to claim 14, wherein the flow guide means (11, 12) comprises ribs provided on the inner side of the fan plate (9).

16. Disk drive unit according to claim 11, wherein the housing (7) of the centrifugal blower (5) is mounted with one side thereof flush with the fan plate (9).

17. Disk drive unit according to claim 13, wherein the fan plate (9) is part of the housing (10) of the disk drive unit.

18. Disk drive unit according to claim 14, wherein the fan plate (9) and the housing (7) of the blower (5) form an integral part.

19. Cooling device for an optical pickup unit of a disk drive unit, for directing a cooling air stream to the optical pickup unit, said cooling device comprising a housing (7) accommodating a centrifugal blower (5) having an axis of rotation, the housing having mounting means (9) to mount the housing to the disk drive unit such that the axis of rotation (5′) of the centrifugal blower (5) is substantially parallel to that (2′) of a turntable (3) of the disk drive unit, wherein the housing (7) is attached to a side of the disk drive unit within the height dimensions of the disk drive unit.
